(19) United States
(12) Patent Application Publication
(10) Pub. No.: US 2006/0111235 A1
(43) Pub. Date: May 25, 2006

(54) Method of manufacturing ferromagnetic particle exothermic elements

(76) Inventors: Shinjiro Domi, Tokyo (JP); Yasuhiro Saito, Osaka (JP); Shigehito Deki, Hyogo-ken (JP)

Correspondence Address: FULBRIGHT & JAWORSKI, LLP, 666 FIFTH AVE, NEW YORK, NY, 10103-3198, US

(21) Appl. No.: 10/523,738

(22) PCT Filed: Aug. 5, 2003
(86) PCT No.: PCT/JP03/09960

§ 371 Date: Oct. 13, 2005

(30) Foreign Application Priority Data
Aug. 6, 2002 (JP) 2002-229035
Aug. 12, 2002 (JP) 2002-234837

(51) Int. Cl. B01J 23/00

(52) U.S. Cl. 502/304

(57) ABSTRACT

A method of manufacturing ferromagnetic particle exothermic elements for performing a deposition treatment for causing a treating aqueous solution containing fluorine and iron to contact nucleus particles, to deposit iron hydroxide and form layers around the nucleus particles, and an after-treatment for heating the iron hydroxide layers to change them into ferromagnetic layers, thereby producing ferromagnetic particle exothermic elements with outside of the nucleus particles covered by the ferromagnetic layers, wherein, in time of the deposition treatment, a reaction initiator that reacts with hydrogen fluoride is added to said treating aqueous solution.

### TECHNICAL FIELD

The present invention relates to a method of manufacturing ferromagnetic particle exothermic elements, in which a deposition treatment is carried out to place a treating aqueous solution containing fluorine and iron in contact with nucleus particles, and deposit iron hydroxide to form layers around the nucleus particles, and an after-treatment is carried out to heat the iron hydroxide layers and change them into ferromagnetic layers, thereby to produce ferromagnetic particle exothermic elements having the outside of the nucleus particles covered by the ferromagnetic layers.

### BACKGROUND ART

Ferromagnetic particle exothermic elements of this type have been attracting attention in recent years, for their heat-generating characteristic of generating heat by magnetic hysteresis loss when placed under an ac magnetic field. For example, a possibility of applying their heat generation characteristic to the hyperthermic treatment of cancer is considered. In the hyperthermic treatment of cancer, the ferromagnetic particle exothermic elements are introduced into the body by means of a catheter or the like, a part having the ferromagnetic particle exothermic elements embedded therein is placed in the ac magnetic field, and a tumor portion is locally heated by using the heat generation due to the magnetic hysteresis loss of the ferromagnetic particle exothermic elements, thereby to destroy only cancer cells.

Incidentally, in manufacturing such ferromagnetic particle exothermic elements, the following manufacturing process has been proposed since a large quantity of ferromagnetic particle exothermic elements may be manufactured in a simple way: (see, for example, “Ceramics for Treatment of Cancer, Chemical Industry, Vol. 52, No. 5, (2001) p 38-43”, hereinafter referred to as the document).

According to this, a treating aqueous solution containing fluorine and iron (for example, an HF aqueous solution containing Fe₃O₄ in saturated concentration) is prepared first. A deposition treatment is carried out to place the treating aqueous solution in contact with nucleus particles simply by immersing the nucleus particles in the treating aqueous solution, and deposit iron hydroxide to form layers around the nucleus particles. Then, an after-treatment is carried out to heat the iron hydroxide layers and change them into ferromagnetic layers, thereby to obtain ferromagnetic particle exothermic elements having the outside of the nucleus particles covered by the ferromagnetic layers.

Specifically, silica glass microspheres are immersed as the nucleus particles in a hydrofluoric acid solution containing Fe₃O₄ in saturated concentration, to deposit and form iron hydroxide layers. Further, these are heat-treated in a reducing atmosphere gas to obtain microspheres with a diameter of about 25 μm.

However, as a result of follow-up experiment conducted by Inventors herein based on the description in the above document, it has been found that the depositing reaction of iron hydroxide is unstable, and iron hydroxide layers cannot be sometimes be deposited effective.

The present invention has been made having regard to the state of the art noted above, and its object is to provide a manufacturing method which can manufacture ferromagnetic particle exothermic elements steadily, and is excellent in productivity.

### DISCLOSURE OF THE INVENTION

A first characteristic feature of the present invention lies in a method of manufacturing ferromagnetic particle exothermic elements for performing a deposition treatment for causing a treating aqueous solution containing fluorine and iron to contact nucleus particles, to deposit iron hydroxide and form layers around the nucleus particles, and an after-treatment for heating the iron hydroxide layers to change into ferromagnetic layers, thereby producing ferromagnetic particle exothermic elements with the outside of said nucleus particles covered by said ferromagnetic layers, wherein, in time of said deposition treatment, a reaction initiator that reacts with hydrogen fluoride is added to said treating aqueous solution.

It is believed that the treating aqueous solution containing fluorine and iron is in the state of equilibrium shown in the following chemical formula 1, and by the reaction in the following chemical formula 2, iron hydroxide deposits around the nucleus particles to form iron hydroxide layers thereon.
[FeF₆₋ₙ(OH)ₙ]³⁻+(6−n) H₂O [symbol] [Fe(OH)₆]³⁻+(6−n) HF (chemical formula 1)
[Fe(OH)₆]³⁻→dehydration→β-FeOOH (chemical formula 2)

That is, in chemical formula 1, [Fe(OH)₆]³⁻ is a very unstable complex ion. When the treating aqueous solution contacts the nucleus particles, as shown in chemical formula 2, [Fe(OH)₆]³⁻ instantly undergoes a dehydrating condensation reaction to become β-FeOOH (iron hydroxide). β-FeOOH deposits around the nucleus particles to form layers thereon.

According to the first feature of the present invention, a reaction initiator that reacts with hydrogen fluoride is added to the treating aqueous solution in time of the deposition treatment. The state of equilibrium of reaction in chemical formula 1 is transferred to the right-hand side to increase intentionally the ratio of [Fe(OH)₆]³⁻. By the reaction in chemical formula 2, β-FeOOH is efficiently deposited around the nucleus particles to form its layers.

Thus, ferromagnetic particle exothermic elements can now be manufactured stably. For this reason, compared with the prior art, iron hydroxide layers may be formed with large thickness efficiently. Those having ferromagnetic layers with increased thickness are efficiently changed from the iron hydroxide layers by heating. It is possible to manufacture efficiently ferromagnetic particle exothermic elements expected to generate an increased amount of heat.

A second characteristic feature of the present invention lies in that, in the first characteristic feature of the present invention noted above, said reaction initiator is added to said treating aqueous solution successively as the time of said deposition treatment passes.

That is, by adding the reaction initiator that reacts with hydrogen fluoride to the treating aqueous solution, the ratio [Fe(OH)C]³⁻ can be increased intentionally, as noted above, which forms the basis for deposition of iron hydroxide. When, for example, the reaction initiator is supplied in a large quantity at a time to increase the ratio of [Fe(OH)₆]³⁻ excessively in a short term, iron hydroxide will deposit not only on the nucleus particles, but automatically in the treating aqueous solution without contacting the nucleus particles. It will then be difficult to form iron hydroxide layers outside the nucleus particles effectively.

However, according to the second feature of the present invention, the reaction initiator is added to the treating aqueous solution successively as the time of the deposition treatment passes. Thus, while preventing the ratio of [Fe(OH)₆]³⁻ from increasing more than necessary, the deposition of iron hydroxide around the nucleus particles is maintained in steady condition over a long period of time, thereby efficiently forming sufficient iron hydroxide layers outside the nucleus particles.

A third characteristic feature of the present invention lies in that, in the second characteristic feature of the present invention noted above, the reaction initiator is added in small quantities at early stages of deposition of iron hydroxide, and in increased quantities afterward.

According to the third feature of the present invention, by adding the reaction initiator in small quantities at early stages of deposition of iron hydroxide, and in increased quantities afterward, the initiator is added in quantities suitable to the deposition of iron hydroxide. The ferromagnetic particle exothermic elements may thereby be manufactured stably and efficiently.

That is, at the early stages of the deposition of iron hydroxide, iron hydroxide which is heterogeneous to the nucleus particles cannot deposit easily on the surfaces of the nucleus particles. The reaction initiator is added in small quantities to keep a low deposition rate of iron hydroxide, thereby to cause iron hydroxide to deposit reliably on the outer surfaces of the nucleus particles, while preventing iron hydroxide from depositing independently in the treating aqueous solution.

On the other hand, when the outer surfaces of the nucleus particles are covered by iron hydroxide layers about 0.5 μm thick, iron hydroxide will easily deposit on the homogeneous iron hydroxide layers. Even if the ratio of [Fe(OH)₆]³⁻ is made excessive to increase the deposition rate of iron hydroxide, the phenomenon of iron hydroxide depositing independently in the treating aqueous solution will hardly take place. Moreover, since the particles having the nucleus particles as the nucleus have their surface area increasing with particle size, an increased quantity of iron hydroxide is needed, with elapse of time, for forming the iron hydroxide layers per fixed thickness.

Thus, by adding increased quantities of the reaction initiators after the early stages of deposition, the quantities added are suited to the deposition of iron hydroxide. Ferromagnetic particle exothermic elements of desired size may now be manufactured stably and efficiently.

A fourth characteristic feature of the present invention lies in that, in the third characteristic feature of the present invention noted above, a hydrogen ion concentration (pH) in the treating aqueous solution and a molar concentration ratio (X) of fluorine to iron in the treating aqueous solution before addition of said reaction initiator satisfy relations pH≦3.5 and X≦4.

A fifth characteristic feature of the present invention lies in that, in the third characteristic feature of the present invention noted above, a hydrogen ion concentration (pH) in the treating aqueous solution before addition of said reaction initiator and a molar concentration of iron (Y) in the treating aqueous solution after addition of said reaction initiator satisfy relations 3.5<pH<6 and 0.001≦Y≦0.5.

According to the fourth feature or fifth feature of the present invention, a hydrogen ion concentration (pH) in the treating aqueous solution and a molar concentration ratio (X) of fluorine to iron in the treating aqueous solution before addition of said reaction initiator, or a hydrogen ion concentration (pH) in the treating aqueous solution before addition of said reaction initiator and a molar concentration of iron (Y) in the treating aqueous solution after addition of said reaction initiator, satisfy the predetermined relations, respectively. This provides an advantage that, as shown in a subsequent embodiment, iron hydroxide layers may be formed in a predetermined quantity in a short period of time.

That is, when pH≦3.5 and X>4, the concentration of fluorine in the treating aqueous solution is too high. Then, even if the reaction initiator is added in large quantities, it is difficult to transfer the state of equilibrium of reaction in chemical formula 1 to the right-hand side to increase the ratio of [Fe(OH)₆]³⁻ efficiently. For this reason, it is advantageous to satisfy the relations pH≦3.5 and X≦4.

On the other hand, when Y>0.5 or pH≧6, [Fe(OH)₆]³⁻ in chemical formula 1 becomes very unstable. An external stimulus such as a minute temperature change or change in concentration would cause the state of equilibrium of reaction in chemical formula 1 to transfer to the right-hand side automatically, without adding the reaction initiator, whereby iron hydroxide deposits in large quantities, the deposition being out of control. When Y<0.001, the concentration of iron in the treating aqueous solution after addition of the reaction initiator addition is too low, and a deposition in sufficient quantity of iron hydroxide does not take place. For this reason, it is advantageous to satisfy the relations 3.5<pH<6 and 0.001≦Y≦0.5.

A sixth characteristic feature of the present invention lies in that, in the fourth or fifth characteristic feature of the present invention noted above, said treating aqueous solution has, dissolved therein, one or more iron raw materials selected from FeF₃, FeF₂, Fe₂F₅, FeF₃·3H₂O, FeF₃·4.5H₂O, FeCl₂, FeCl₂·4H₂O, FeCl₃, FeCl₃·6H₂O, Fe(ClO4)₂·6H₂O, Fe(ClO₄)₃·6H₂O, FeBr₂, FeBr₂·6H₂O, FeBr₃, FeBr₃·6H₂O, FeI₂, FeI₂·4H₂O, FeO, Fe₂O₃, Fe₃O₄, Fe(OH)₂, FeOOH, FeSO₄·7H₂O, Fe₂ (SO₄)₃·9H₂O and Fe.

According to the sixth feature of the present invention, the above iron salts all have proper water solubility, and when dissolved in a solvent to make a treating aqueous solution, fluorine and iron coexist in ionic state. Thus, these substances can be used conveniently as iron raw materials in the present invention.

A seventh characteristic feature of the present invention lies in that, in the sixth characteristic feature of the present invention noted above, said treating aqueous solution has, dissolved therein, one or more iron raw materials selected from FeF₃, FeF₂, Fe₂F₅, FeF₃·3H₂O and FeF₃·4.5H₂O.

According to the seventh feature of the present invention, the above iron raw materials are all formed of iron and fluorine, and do not generate other ions. Thus, there exist hardly any factors that inhibit the deposition reaction, allowing for stable control of the reaction.

An eighth characteristic feature of the present invention lies in that, in the seventh characteristic feature of the present invention noted above, said treating aqueous solution is prepared by dissolving said iron raw material in hydrofluoric acid.

According to the eighth feature of the present invention, the iron raw material is dissolved in hydrofluoric acid. Since the iron raw materials noted in the sixth feature are easily dissolvable, iron concentration in the treating aqueous solution may be adjusted with ease.

A ninth characteristic feature of the present invention lies in that, in the seventh characteristic feature of the present invention noted above, said treating aqueous solution is prepared by dissolving said iron raw material in a mixed solution of hydrofluoric acid and an ammonium fluoride aqueous solution.

According to the ninth feature of the present invention, the iron raw material is dissolved in a mixed solution of hydrofluoric acid and an ammonium fluoride aqueous solution. Since the iron raw materials noted in the sixth feature are easily dissolvable, not only is iron concentration in the treating aqueous solution adjustable with ease, but pH adjustment of the treating aqueous solution may be carried out easily by varying the mixing ratio between hydrofluoric acid and ammonium fluoride aqueous solution. Thus, it is easy to control the quantity of deposition of iron hydroxide.

A tenth or eleventh characteristic feature of the present invention lies in that, in the eighth or ninth characteristic feature of the present invention noted above, said reaction initiator comprises one or more additives selected from H₃BO₃, FeCl₂, FeCl₃, NaOH, NH₃, Al, Ti, Fe, Ni, Mg, Cu, Zn, Si, SiO₂, CaO, B₂O₃, Al₂O₃ and MgO.

According to the tenth feature or eleventh feature of the present invention, the reaction initiator comprising any one of the above reacts with hydrogen fluoride in the treating aqueous solution to generate a stable fluoro complex compound or fluoride. Thus, the deposition of iron hydroxide is not inhibited and iron hydroxide layers are formed efficiently.

An example of reaction between the reaction initiator and hydrogen fluoride is shown in the following chemical formula 3 and chemical formula 4. Chemical formula 3 is a reaction occurring when H₃BO₃ (boric acid) used as the reaction initiator. Chemical formula 4 is a reaction occurring when Al (aluminum) is used as the reaction initiator.
H₃BO₃+4HF [symbol] BF_{4hu -}+H₃O⁺+2H₂O (chemical formula 3)
Al+6HF [symbol] H₃AlF₆+3/2H₂ (chemical formula 4)

A twelfth or thirteenth characteristic feature of the present invention lies in that, in the tenth or eleventh characteristic feature of the present invention noted above, said reaction initiator comprises H₃BO₃.

According to the twelfth feature or thirteenth feature of the present invention, since the reaction initiator is H₃BO₃, it is advantageous in that the iron hydroxide layers may be deposited steadily and continuously, and impurities other than iron hydroxide do not deposit.

A fourteenth or fifteenth characteristic feature of the present invention lies in that, in the twelfth or thirteenth characteristic feature of the present invention noted above, said after-treatment is carried out to form gamma hematite layers as the ferromagnetic layers by heating in an inert atmosphere or reducing atmosphere.

According to the fourteenth feature or fifteenth feature of the present invention, it is advantageous in that, by heating in an inert atmosphere or reducing atmosphere, the ferromagnetic layers changed from the iron hydroxide layers may reliably be gamma hematite layers.

### BRIEF DESCRIPTION OF THE DRAWINGS

FIG. 1 is a schematic view of a film depositing apparatus, and

FIG. 2 is a schematic view of a reducing furnace.

### BEST MODE FOR CARRYING OUT THE INVENTION

Specific embodiments will be shown in order to confirm the effects of the present invention, but the invention is not limited thereto.

(Embodiment 1)

Samples 1-7 and samples 11-13 were prepared by performing a deposition treatment, as follows, to place a treating aqueous solution containing fluorine and iron in contact with nucleus particles.

FeF₃, an aqueous solution of HF, an aqueous solution of NH₄F and water were mixed in predetermined ratios, and for each of samples 1-7 and samples 11-13, a treating aqueous solution having the Fe concentration, HF concentration and NH₄F concentration shown in Table 1-1 was used.

| | Fe concentration | HF concentration | NH₄F concentration |
|---|---|---|---|
| | (mol/l) | (mol/l) | (mol/l) |
| Sample 1 | 0.089 | 0.0083 | 0 |
| Sample 2 | 0.089 | 0.0008 | 0 |
| Sample 3 | 1.000 | 1.0000 | 1 |
| Sample 4 | 0.300 | 1.0000 | 1 |
| Sample 5 | 0.100 | 1.0000 | 1 |
| Sample 6 | 0.150 | 0.0083 | 0 |
| Sample 7 | 0.250 | 0.0167 | 0 |
| Sample 11 | 0.089 | 0.5000 | 0 |
| Sample 12 | 0.100 | 2.0000 | 0 |
| Sample 13 | 1.000 | 1.0000 | 1 |

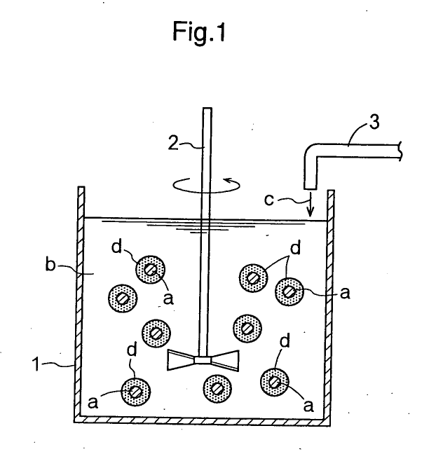

Then, a deposition treatment was carried out by using a film depositing apparatus, and using 0.3 g of spherical silica particles having a mean particle diameter of about 12 μm as an example of nucleus particles. As shown in FIG. 1, the film depositing apparatus used includes a container 1 for storing the silica particles ‘a’ and the treating aqueous solution ‘b’, a stirrer 2 for stirring the treating aqueous solution ‘b’, and a pipe 3 for adding a reaction initiator ‘c’. In the figure, ‘d’ denotes iron hydroxide layers. After putting the silica particles into the treating aqueous solution and agitating it for 30 minutes with the stirrer, an aqueous solution of boric acid (H₃BO₃) of 0.5 mol/l was added as the reaction initiator. The aqueous solution of boric acid acting as the reaction initiator was added to the treating aqueous solution at the ratios shown in Table 1-2.

That is, for samples 1, 2, 6, 7, 11 and 12, before adding the reaction initiator, the ratios of FeF₃ to HF were adjusted so that the treating aqueous solution might have the pH and molar concentration ratios of fluorine to iron (i.e. [molar concentration of fluorine]/[molar concentration of iron]) shown in Table 1-3. The molar concentration of iron after the addition of the reaction initiator for each sample had a value shown in Table 1-3.

On the other hand, for samples 3-5 and sample 13, before addition of the reaction initiator, pH of the treating aqueous solution was adjusted as shown in Table 1-4, and after adding the reaction initiator, the ratio of the treating aqueous solution to the aqueous solution of boric acid was adjusted so that the concentration of iron (Fe concentration) in the treating aqueous solution might have the values shown in Table 1-4. The [molar concentration of fluorine]/[molar concentration of iron] before the addition of the reaction initiator for each sample had a value shown in Table 1-4.

At all times, after adding the reaction initiator, the temperature of the treating aqueous solution was maintained at 30° C., and agitation was carried out for about 16 hours. After the 16 hours, a centrifugal separator was used to separate from the treating aqueous solution the silica particles having iron hydroxide layers deposited thereon.

TABLE 1-2

| | | aqueous solution of boric acid |
|---|---|---|
| | treating aqueous | (reaction initiator) |
| | solution (ml) | (mol/l) |
| Sample 1 | 50 | 50 |
| Sample 2 | 90 | 10 |
| Sample 3 | 30 | 70 |
| Sample 4 | 30 | 70 |
| Sample 5 | 15 | 80 |
| Sample 6 | 100 | 5 |
| Sample 7 | 100 | 15 |
| Sample 11 | 40 | 20 |
| Sample 12 | 10 | 80 |
| Sample 13 | 100 | 80 |

TABLE 1-3

| | before addition of | | | |
|---|---|---|---|---|
| | reaction initiator | | | |
| | | X([molar | molar | |
| | | concentration | concentration | |
| | | of fluorine]/ | of iron after | |
| | | [molar | addition of | number |
| | | concentration | reaction | of |
| | pH | of iron]) | initiator | days |
| Sample 1 | 2.77 | 3.09 | 0.045 | 20 days |
| Sample 2 | 3.25 | 3.01 | 0.080 | 20 days |
| Sample 6 | 2.50 | 3.07 | 0.143 | 12 days |
| Sample 7 | 2.40 | 3.06 | 0.217 | 12 days |
| Sample 11 | 1.65 | 8.70 | 0.059 | — |
| Sample 12 | 3.18 | 23.0 | 0.011 | — |

TABLE 1-4

| | before addition of | | | |
|---|---|---|---|---|
| | reaction initiator | | | |
| | | [molar | | |
| | | concentration | | |
| | | of | after addition of | |
| | | fluorine]/ | reaction initiator | |
| | | [molar | Y (molar) | number |
| | | concentration | concentration | of |
| | pH | of iron] | of iron) | days |
| Sample 3 | 3.77 | 5.0 | 0.300 | 15 days |
| Sample 4 | 4.50 | 9.7 | 0.090 | 20 days |
| Sample 5 | 4.78 | 23 | 0.016 | 12 days |
| Sample 13 | 3.77 | 5.0 | 0.556 | — |

The above steps were carried out once a day. These steps were repeated until the iron hydroxide layers around the silica particles became 6.5 μm thick. The required numbers of times are shown as numbers of days in Table 1-3 and Table 1-4. It was confirmed by XRD (X-ray diffraction) that the iron hydroxide layers were β-FeOOH, and the thicknesses of the iron hydroxide layers were confirmed a SEM (scanning electron microscope).

As seen from samples 1, 2, 6 and 7 in Table 1-3, what had iron hydroxide layers of uniform thickness as a whole was obtained in short periods of time when, before addition of the reaction initiator, the hydrogen ion concentration (pH) in the treating aqueous solution and the molar concentration ratio (X) of fluorine to iron in the treating aqueous solution satisfied relations pH≦3.5 and X≦4. On the other hand, as exemplified by samples 11 and 12 in Table 1-3, no iron hydroxide layer was formed despite addition of the reaction initiator when X>4 although the treating aqueous solution before addition of the reaction initiator was pH≦3.5.

As seen from samples 3, 4 and 5 in Table 1-4, what had iron hydroxide layers of uniform thickness as a whole was obtained in short periods of time when the pH of the treating aqueous solution before addition of the reaction initiator and the molar concentration of iron (Y) in the treating aqueous solution after addition of the reaction initiator satisfied relations 3.5<pH<6 and 0.001≦Y≦0.5. On the other hand, as exemplified by sample 13 in Table 1-4, no iron hydroxide layer was formed when X (molar concentration of iron) in the treating aqueous solution before addition of the reaction initiator exceeded 0.5, although the treating aqueous solution before addition of the reaction initiator was 3.5<pH<6.

And all of samples 1-7, after the deposition treatment, were heated at 650° C. for 1 h and were allowed to cool under a reducing atmosphere of a mixed gas of CO₂ and H₂, to change the iron hydroxide layers to gamma hematite layers. As a result, ferromagnetic particle exothermic elements with the silica particles covered by the gamma hematite layers were obtained.

A conventional method of performing a deposition treatment was tried separately, as a comparative example, without using a reaction initiator. As an example of conventional method, 0.3 g of silica particles were immersed in 600 ml of a 30° C. 1% HF solution containing Fe₃O₄ in saturated concentration, which was then agitated. No iron hydroxide layer was deposited.

(Embodiment 2)

Samples 1-4 were prepared by performing a deposition treatment, as follows, to place a treating aqueous solution containing fluorine and iron in contact with nucleus particles.

A treating aqueous solution was first prepared by mixing 5.09 g of FeF₃, 50 ml of hydrofluoric acid with an HF concentration of 0.1% by weight, and 250 ml of pure water.

Then, a deposition treatment was carried out, in which 0.9 g of spherical silica particles having a mean particle diameter of about 12 μm as an example of nucleus particles were put in 300 ml of the treating aqueous solution, which was agitated by a stirrer for 30 minutes. Thereafter, an aqueous solution of boric acid (H₃BO₃) of 0.5mol/l is supplied as a reaction initiator, using a tubing pump, successively as time passes, as shown in Table 2-1 to Table 2-4 (Table 2-1 being for sample 1, Table 2-2 for sample 2, Table 2-3 for sample 3 and Table 2-4 for sample 4). This deposition treatment was carried out by keeping the solution temperature at 30° C. in an incubator and agitating it. The whole quantity of treating solution was changed upon passage of the seventh day, and the samples having particle sizes as shown in Table 2-1 to Table 2-4 were obtained on the 12th day.

TABLE 2-1
Sample 1

| number of | | | | | | | | | | | | |
|---|---|---|---|---|---|---|---|---|---|---|---|---|
| days of | | | | | | | | | | | | |
| treatment | 1 | 2 | 3 | 4 | 5 | 6 | 7 | 8 | 9 | 10 | 11 | 12 |
| supply of | 12 | 14 | 16 | 18 | 21 | 24 | 26 | 29 | 32 | 35 | 39 | 42 |
| reaction | | | | | | | | | | | | |
| initiator | | | | | | | | | | | | |
| (ml/day) | | | | | | | | | | | | |
| grain size | 13 | 14 | 15 | 16 | 17 | 18 | 19 | 20 | 21 | 22 | 23 | 24 |
| (μm) | | | | | | | | | | | | |

TABLE 2-2
Sample 2

| number of | | | | | | | | | | | | |
|---|---|---|---|---|---|---|---|---|---|---|---|---|
| days of | | | | | | | | | | | | |
| treatment | 1 | 2 | 3 | 4 | 5 | 6 | 7 | 8 | 9 | 10 | 11 | 12 |
| supply of | 12 | 12 | 12 | 12 | 12 | 12 | 12 | 12 | 12 | 12 | 12 | 12 |
| reaction | | | | | | | | | | | | |
| initiator | | | | | | | | | | | | |
| (ml/day) | | | | | | | | | | | | |
| grain size | 13 | 13.9 | 14.6 | 15.3 | 15.8 | 16.3 | 16.8 | 17.2 | 17.6 | 17.9 | 18.2 | 18.5 |
| (μm) | | | | | | | | | | | | |

TABLE 2-3
Sample 3

| number of | | | | | | | | | | | | |
|---|---|---|---|---|---|---|---|---|---|---|---|---|
| days of | | | | | | | | | | | | |
| treatment | 1 | 2 | 3 | 4 | 5 | 6 | 7 | 8 | 9 | 10 | 11 | 12 |
| supply of | 12 | 0 | 0 | 0 | 0 | 0 | 0 | 0 | 0 | 0 | 0 | 0 |
| reaction | | | | | | | | | | | | |
| initiator | | | | | | | | | | | | |
| (ml/day) | | | | | | | | | | | | |
| grain size | 13 | 13.1 | 13.1 | 13.1 | 13.1 | 13.1 | 13.1 | 13.1 | 13.1 | 13.1 | 13.1 | 13.1 |
| (μm) | | | | | | | | | | | | |

TABLE 2-4
Sample 3

| number | | | | | | | | | | | | |
|---|---|---|---|---|---|---|---|---|---|---|---|---|
| of days | | | | | | | | | | | | |
| of | | | | | | | | | | | | |
| treat- | | | | | | | | | | | | |
| ment | 1 | 2 | 3 | 4 | 5 | 6 | 7 | 8 | 9 | 10 | 11 | 12 |
| supply | 100 | 0 | 0 | 0 | 0 | 0 | 0 | 0 | 0 | 0 | 0 | 0 |
| of | | | | | | | | | | | | |
| reaction | | | | | | | | | | | | |
| initiator | | | | | | | | | | | | |
| (ml/ | | | | | | | | | | | | |
| day) | | | | | | | | | | | | |
| grain | 14 | 14.5 | 14.8 | 15 | 15 | 15 | 15 | 15 | 15 | 15 | 15 | 15 |
| size | | | | | | | | | | | | |
| (μm) | | | | | | | | | | | | |

As shown in Table 2-3 and Table 2-4, for sample 3 and sample 4, the reaction initiator was supplied only on the first day, and therefore particle size did not increase in a suitable way. Moreover, for sample 4, since the reaction initiator was supplied in a large quantity at a time, some iron hydroxide deposited independently in the treating aqueous solution, and iron hydroxide layers were not efficiently formed outside the nucleus particles.

On the other hand, for sample 1 and sample 2, as shown in Table 2-1 and Table 2-2, it was confirmed that, by supplying the reaction initiator successively as time passes, the deposition of iron hydroxide around the nucleus particles was maintained in steady condition over a long period of time, thereby efficiently forming sufficient iron hydroxide layers outside the nucleus particles. Especially, for sample 1, large particle sizes were obtained stably by supplying the reaction initiator in small quantities at early stages of deposition of iron hydroxide, and in increased quantities afterward.

All of sample 1 to sample 4, after the deposition treatment, were heated at 650° C. for 1 h and were allowed to cool under a reducing atmosphere of a mixed gas of CO₂ and H₂, to change the iron hydroxide layers to gamma hematite layers. As a result, ferromagnetic particle exothermic elements with the silica particles covered by the gamma hematite layers were obtained.

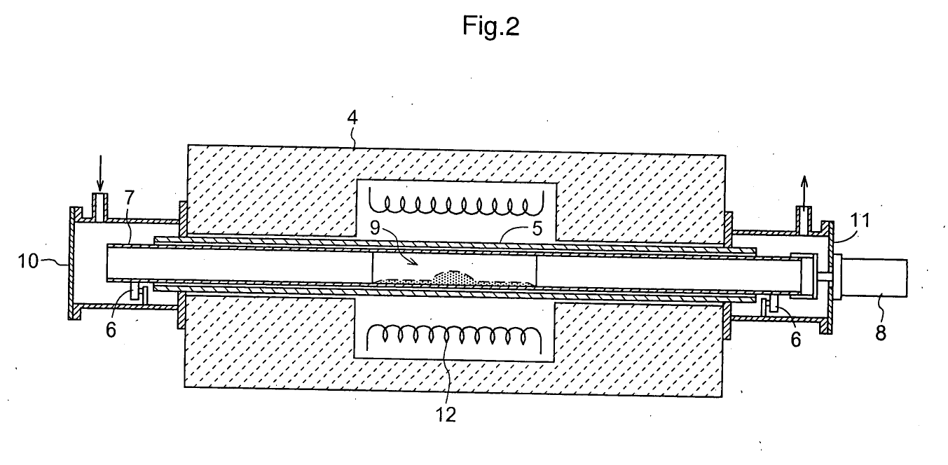

The reducing furnace used in this heating treatment, as shown in FIG. 2, includes a heating furnace 4, a furnace tube 5 formed of quartz and disposed centrally of the heating furnace 4, a rotating pipe 7 formed of quartz and supported by a plurality of rollers 6 to be rotatable inside the furnace tube 5, and a motor 8 for driving and rotating the rotating pipe 7. A sample chamber 9 is formed inside the furnace tube 5, and a heater 12 is disposed to surround the sample chamber 9. Flanges 10 and 11 are arranged at opposite ends of the furnace tube 5 for maintaining a reducing atmosphere therein. While introducing a reducing gas from one flange 10 and discharging the reducing gas from the other flange 11, heating treatment is carried out in the reducing atmosphere therebetween.

[Other Embodiments]

Other embodiments will be described below.

<1> The treating aqueous solution is not limited to FeF₃ described hereinbefore. For example, a treating aqueous solution may have, dissolved in a solvent, one or more iron raw materials selected from FeF₃, FeF₂, Fe₂F₅, FeF₃·3H₂O, FeF₃·4.5H₂O, FeCl₂, FeCl₂·4H₂O, FeCl₃,

FeCl₃·6H₂O, Fe(ClO₄)₂·6H₂O, Fe₃(ClO₄)₃·6H₂O, FeBr₂, FeBr₂·6H₂O, FeBr₃, FeBr₃·6H₂O, FeI₂, FeI₂·4H₂O, FeO, Fe₂O₃, Fe₃O₄, Fe(OH)₂, FeOOH, FeSO₄·7H₂O, Fe₂ (SO₄)₃·9H₂O and Fe. Then, since fluorine and iron coexist in ionic state, it may conveniently be used in the present invention as an iron raw material.

Further, the treating aqueous solution is not limited to those having an iron raw material dissolved in hydrofluoric acid or in a mixed solution of hydrofluoric acid and an ammonium fluoride aqueous solution as noted hereinbefore. For example, a treating aqueous solution containing fluorine and iron may be prepared by dissolving FeF₃, FeF₂, FeF₃·4.5H₂O or the like in water or various other solvents.

<2> The reaction initiator is not limited to H₃BO₃ noted hereinbefore, but may be any substance as long as it reacts with hydrogen fluoride. For example, it is possible, to use one or more additives selected from H₃BO₃, FeCl₂, FeCl₃, NaOH, NH₃, Al, Ti, Fe, Ni, Mg, Cu, Zn, Si, SiO₂, CaO, B₂O₃, Al₂O₃ and MgO. Any one of these substances will react with hydrogen fluoride in the treating aqueous solution, to generate a stable fluoro complex compound or fluoride. It is suitable in that the deposition of iron hydroxide is not inhibited and iron hydroxide layers are formed efficiently.

Incidentally, it is preferable to disperse the nucleus particles in time of deposition treatment since iron hydroxide layers may be formed around the nucleus particles more uniformly. Instead of agitating the treating aqueous solution as described hereinbefore, the treating aqueous solution may, for example, be shaken by a shaker, or various other dispersing devices may be used (e.g. a homogenizer for ultrasonic dispersion or mechanical dispersion).

<3> The nucleus particles, apart from being spherical, may have any shape such as round shape or square shape since, with deposition of the iron hydroxide layers, they will automatically change to spherical shape having minimal surface energy. The nucleus particles shaped spherical or nearly spherical, in particular, are preferred in that the ferromagnetic particle exothermic elements tend to be uniform, eliminating the necessity of carrying out a classification process. Especially where the nucleus particles are truly spherical, with a mean diameter of 0.5 to 10 μm and a coefficient of variation at 15% or less, it is particularly desirable in that particle size after formation of the iron hydroxide layers may be uniformed to obtain ferromagnetic particles of uniform particle size. Nucleus particles which fulfill such conditions may be of silicon dioxide (silica), titanium dioxide and so on. Among these substances, silicon dioxide (silica) particles are convenient, since a uniform particle size may easily be secured by methods such as liquid phase deposition reaction that neutralizes an aqueous solution of sodium silicate, and the sol gel treatment that uses tetra-ethoxy silane as the starting material.

The nucleus particles used may be any type as long as they are excellent in dispersibility or chemical stability in a treating aqueous solution that deposits iron hydroxide. For example, nucleus particles of a material having ferromagnetism are expected to generate heat by magnetic hysteresis loss.

And the deposition treatment is not limited to the form that immerses the nucleus particles in the treating aqueous solution, but will serve the purpose as long as contact is made between the treating aqueous solution and nucleus particles. For example, the treating aqueous solution may be made to flow over the nucleus particles, or the treating aqueous solution may be sprayed over the nucleus particles.

<4>In supplying the treating aqueous solution with the reaction initiator successively as time passes as shown in Embodiment 2, it may be supplied continuously, may be supplied intermittently, or may be supplied at every fixed interval.

The supply of the reaction initiator may be adjusted by the quantity of supply itself as described hereinbefore, or may of course be adjusted by its concentration level.

Embodiment 2 has been described, exemplifying the treating aqueous solution being changed after lapse of seven days. This is not limitative. For example, the treating aqueous solution may be changed every day, or at any desired setting.

For example, two pumps may be installed in the reaction vessel containing the treating aqueous solution, one of the pumps being used in introducing into the reaction vessel, successively, a predetermined quantity of new treating aqueous solution with an additive mixed therein beforehand, and the other pump in discharging from the reaction vessel, successively, the same quantity of treating aqueous solution.

<5>In an after-treatment, the iron hydroxide layers may be heated and changed into ferromagnetic layers. The ferromagnetic layers are not limited to the gamma hematite layers as illustrated hereinbefore, but may be ferrite layers, formed from the iron hydroxide layers by heating in an inert atmosphere or reducing atmosphere.

### INDUSTRIAL UTILITY

Ferromagnetic particle exothermic elements manufactured by the present invention are applicable not only to hyperthermic treatment, but to various purposes by using the heat generation characteristic of generating heat by magnetic hysteresis loss.

1. A method of manufacturing ferromagnetic particle exothermic elements for performing a deposition treatment for causing a treating aqueous solution containing fluorine and iron to contact nucleus particles, to deposit iron hydroxide and form layers around the nucleus particles, and an after-treatment for heating the iron hydroxide layers to change them into ferromagnetic layers, thereby producing ferromagnetic particle exothermic elements with outside of said nucleus particles covered by said ferromagnetic layers,
wherein, in time of said deposition treatment, a reaction initiator that reacts with hydrogen fluoride is added to said treating aqueous solution.

2. A method of manufacturing ferromagnetic particle exothermic elements as defined in claim 1, wherein said reaction initiator is added to said treating aqueous solution successively as the time of said deposition treatment passes.

3. A method of manufacturing ferromagnetic particle exothermic elements as defined in claim 2, wherein said reaction initiator is added in small quantities at early stages of deposition of said iron hydroxide, and in increased quantities afterward.

4. A method of manufacturing ferromagnetic particle exothermic elements as defined in claim 3, wherein a hydrogen ion concentration (pH) in the treating aqueous solution and a molar concentration ratio (X) of fluorine to iron in the treating aqueous solution before addition of said reaction initiator satisfy relations pH≦3.5 and X≦4.

5. A method of manufacturing ferromagnetic particle exothermic elements as defined in claim 3, wherein a hydrogen ion concentration (pH) in the treating aqueous solution before addition of said reaction initiator and a molar concentration of iron (Y) in the treating aqueous solution after addition of said reaction initiator satisfy relations 3.5<pH<6 and 0.001≦Y≦0.5.

6. A method of manufacturing ferromagnetic particle exothermic elements as defined in claim 4 or 5, wherein said treating aqueous solution has, dissolved therein, one or more iron raw materials selected from FeF₃, FeF₂, Fe₂F₅, FeF₃·3H₂O, FeF₃·4.5H₂O, FeCl₂, FeCl₂·4H₂O, FeCl₃, FeCl₃·6H₂O, Fe(ClO₄)₂·6H₂O, Fe(ClO₄)₃·6H₂O, FeBr₂, FeBr₂·6H₂O, FeBr₃, FeBr₃·6H₂O, FeI₂, FeI₂·4H₂O, FeO, Fe₂O₃, Fe₃O₄, Fe(OH)₂, FeOOH, FeSO₄·7H₂O, Fe₂ (SO₄)₃·9H₂O and Fe.

7. A method of manufacturing ferromagnetic particle exothermic elements as defined in claim 6, wherein said treating aqueous solution has, dissolved therein, one or more iron raw materials selected from FeF₃, FeF₂, Fe₂F₅, FeF₃·3H₂O and FeF₃·4.5H₂O.

8. A method of manufacturing ferromagnetic particle exothermic elements as defined in claim 7, wherein said treating aqueous solution is prepared by dissolving said iron raw material in hydrofluoric acid.

9. A method of manufacturing ferromagnetic particle exothermic elements as defined in claim 7, wherein said treating aqueous solution is prepared by dissolving said iron raw material in a mixed solution of hydrofluoric acid and an ammonium fluoride aqueous solution.

10. A method of manufacturing ferromagnetic particle exothermic elements as defined in claim 8, wherein said reaction initiator comprises one or more additives selected from H₃BO₃, FeCl₂, FeCl₃, NaOH, NH₃, Al, Ti, Fe, Ni, Mg, Cu, Zn, Si, SiO₂, CaO, B₂O₃, Al₂O₃ and MgO.

11. A method of manufacturing ferromagnetic particle exothermic elements as defined in claim 9, wherein said reaction initiator comprises one or more additives selected from H₃BO₃, FeCl₂, FeCl₃, NaOH, NH₃, Al, Ti, Fe, Ni, Mg, Cu, Zn, Si, SiO₂, CaO, B₂O₃, Al₂O₃ and MgO.

12. A method of manufacturing ferromagnetic particle exothermic elements as defined in claim 10, wherein said reaction initiator comprises H₃BO_{3.}

13. A method of manufacturing ferromagnetic particle exothermic elements as defined in claim 11, wherein said reaction initiator comprises H₃BO_{3.}

14. A method of manufacturing ferromagnetic particle exothermic elements as defined in claim 12, wherein said after-treatment is carried out to form gamma hematite layers as the ferromagnetic layers by heating in an inert atmosphere or reducing atmosphere.

15. A method of manufacturing ferromagnetic particle exothermic elements as defined in claim 13, wherein said after-treatment is carried out to form gamma hematite layers as the ferromagnetic layers by heating in an inert atmosphere or reducing atmosphere.
